(19) United States
(12) Patent Application Publication
(10) Pub. No.: US 2003/0012018 A1
(43) Pub. Date: Jan. 16, 2003

(54) Lighting element

(76) Inventor: Manfred Kluth, Hilden (DE)

Correspondence Address: WILLIAM COLLARD, COLLARD & ROE, P.C., 1077 NORTHERN BOULEVARD, ROSLYN, NY, 11576, US

(21) Appl. No.: 10/181,824

(22) PCT Filed: Aug. 30, 2001
(86) PCT No.: PCT/DE01/03285

(30) Foreign Application Priority Data
Nov. 20, 2000 (DE) 100 57 574.9

(51) Int. Cl. F21V 19/04

(52) U.S. Cl. 362/222; 362/223; 362/225; 362/237; 362/249; 362/147; 362/127

(57) ABSTRACT

The invention relates to a lighting element (1), comprising at least one light source (4) and at least one base element (2) which is at least partially provided with a translucent material. The lighting element (1) can be freely put up and the at least one light source (4) is disposed within the base element (2). The lateral surfaces of the lighting element (1) are preferably completely provided with said translucent material, for example a PVC film, so that the light sources (4) within the lighting elements (1) are not visible from the exterior. The individual lighting elements (1) can be easily interconnected via suitable plug-in connectors (5, 8) so that the lighting elements can be simultaneously used as pieces of furniture, for example as room dividers.

The invention relates to a lighting element consisting of at least one base element and at least one light source arranged within the base element. The light source should be freely put up and is covered at least partially on one side with a translucent material.

Lighting elements of the generic type are known for example as cover or wall elements. Such elements mainly consist of a base in which translucent glass or plastic panels are inserted that cover the light source behind it and more or less strongly disperse the light that penetrates them. Lighting elements are also known that have a frame covered by a plastic foil on the side facing the room. This plastic foil on the one hand covers the light sources, and the ceiling or wall and on the other hand it disperses the light so that the room has diffuse lighting conditions. In this context there are also known lighting elements that feature two parallel foils that are objected to by each other facing the room and are in front of the light source, improving light dispersion. In addition, by using two foils the collection of dust and dirt particles visible to the observer on rear side of the foils is avoided. All known lighting elements of the generic type however have the disadvantage that they cannot be used flexibly, but rather are intended exclusively to be mounted on the ceiling or wall. The lighting elements serve therefore purely as light sources without being used, for example, simultaneously as pieces of furniture.

The invention is based on the task of creating a lighting element of the generic type that can be used flexibly, can be integrated into the existing room structure, and if need be used as a piece of furniture.

According to the invention the task is solved by providing several regularly or irregularly arranged light sources affected by a color temperature control system. At least one side is completely covered with a translucent material. A lighting element that can be set up has the advantage that it can be flexibly integrated into the existing room structure and does not-have to be affixed to the ceiling or wall. In addition to its lighting function, a lighting element correspondingly arranged can also be used as a piece of furniture or for example as a flexible room divider. In accordance with the invention at least one light source is arranged within the base element, so that this is integrated into the lighting element and can be flexibly set up. Beyond that, special lighting effects are achieved by several light sources, which illuminate the base from the interior outwards. The lighting element forms a closed unit where no disturbing, protruding elements are visible from the outside. It is especially advantageous when at least one side is completely covered with a translucent material. Additional side surfaces can also be covered with the translucent material as need or purpose require, whereby with a single element, which should be freely set up in a room without further elements, the complete surface of the lighting element can be covered with a translucent material. Moreover, variable lighting elements can be used so that each form a closed unit and can be freely set up within a room. The lighting elements can be set up so that the light sources arranged within the base are not visible and thus a uniform object results that is illuminated from within. Depending on their embodiment, the lighting elements can serve as a screen for individual sections of the room or as a dividing wall or room divider. However, they can also simply be placed freely within the room as a decoration or light source.

Depending on the lighting needs in the room, the special requirements for the illumination and the desired optical effect, several regularly and irregularly arranged light sources can be provided for within the lighting element.

An especially advantageous and pleasant illumination of the room can for example be achieved when several colored light sources are each individually influenced in their intensity, whereby the color temperature of the diffusely emitted light can be controlled. Such light sources emit a frequency and intensity spectrum that corresponds to the spectrum of natural light and thus is considered especially pleasant.

In a preferred embodiment it is provided for that the lighting element can be freely set up, at least one light source is arranged within the base element, and the surface of at least one side is completely covered with translucent material. In this way on the one hand the light source inside the lighting element is not visible and on the other hand the special optical effect of a closed body illuminated from within is guaranteed. Preferably all side surfaces visible from outside should be provided with a translucent material. As already described above, for individual, freely standing lighting elements this can be all side surfaces. If several lighting elements are combined with each other individual side surfaces can also remain open or closed by wood elements etc. If the translucent material partially reflects the light, the light will be especially well dispersed by the multiple reflection between the side surfaces that lie opposite each other. Thus the illumination by the lighting elements appears very uniform and diffuse.

The translucent material can be a foil or a textile material that is translucent for every wavelength of light. The foil or textile material is-,mounted dust-tight on the base in an advantageous way so that a smooth surface is presented without wrinkling. The foil or the textile material can be hung up with a piping that is at least partially wrapped around in a recess of the base element or a profile track. When the light source is turned on the light is transmitted uniformly and with a wide light spectrum. In especially advantageous embodiment of the invention it is provided for that a foil of translucent plastic, for example PVC, is used as the translucent material. Preferably a very thin foil with a thickness of approximately 0.25 mm is used. These foils are translucent for visible light of every wavelength so that even ultraviolet and infrared light in the border area can be transmitted, whereby the observer is given the impression of natural light. Beyond that light under 380 nanometers wavelength can be filtered out so that the bleaching of sensitive materials can be prevented. In addition to these especially advantageous characteristics the foils are also very flexible so that they can be easily mounted on the base element without ripping. A further advantage of such foils is that they are not transparent so that the interior of the lighting elements, especially the light sources, remain hidden. While these foils guarantee optimal protection of the interior of the lighting element from being seen, the emerging light is transmitted through the total spectrum and dispersed beyond that so that a uniform and very pleasant illumination develops. The transparency of the foils for infrared light is especially advantageous since through this infrared receivers and infrared transmitters for controlling the illumination or other devices can be used when the control units are arranged within the lighting element. When several foils are mounted on side surfaces opposite each other sound waves moreover can be effectively absorbed in the space between the foils through multiple reflection and interference effect. The lighting elements consequently in an advantageous way have a positive effect on the acoustics of the room, whereby especially sound reverberations are avoided.

In order to further improve the dispersal of the light in an advantageous way, a special embodiment of the invention provides for translucent material that features an embossed knob-like structure and/or a micro perforation. An additional dispersion of the emerging light is achieved through a knob-like embossment of the surface or a micro perforation. This leads to nearly a complete dissolution of the formation of shadows. Through this an especially homogeneous and shadow-free illumination of the room is made possible. The micro perforation strengthens moreover the sound absorbing effect of the lighting element according to the invention, so that the acoustics can also be further positively influenced through this.

To achieve special effects on the surface of the translucent material devices can be present for the generation of writing, images or visual representations, like for example star constellations. It is especially advantageous here if one or several light sources emit monochromatic light, since different light colors are perceived by an observer with different intensity and thus are considered especially pleasant. For this purpose a light source could in an alternative design also for example additionally be equipped with a filter. In order to achieve varying light effects it has been provided for that several of the same and varying color light sources will be used. They are in an advantageous way each separate, dynamic and their intensity can be controlled. It is furthermore possible to generate certain color effects through corresponding color light sources. By dynamically controlling of the individual light sources even moving images and flowing optical effects can be created. The achieved controllability also makes possible the presentation of changing, static images like for example the presentation of a starry sky or a comet.

In advantageous embodiment of the invention additional electronic devices, for example projectors for slides or acoustical reproduction devices, can be provided for within the framework. With the help of such devices additional optical and/or acoustical effects can be achieved, which can influence the atmosphere of the room. Through a corresponding control system, for example, a coordination of the acoustical and optical effects can be achieved. In this connection fragrance generators can also be used, which can spread pleasant smells in the room.

In advantageous embodiment of the invention it is provided for that the base element consist of wood, plastic and/or metal, for example aluminum. Here it is important that the material used on the one hand gives the lighting element a sufficient stability, but on the other hand is not too heavy so that the lighting element if need be can easily be moved or stacked.

If, on the base element, plate or grate elements are mounted on preferably at least one horizontal side surface, then the lighting element can be integrated in the room simultaneously as a piece of furniture. Through this design especially the horizontal side surfaces can be used for example as shelf space, storage space or a counter. Through this the flexibility of the lighting element according to the invention can be further increased.

In advantageous embodiment of the invention furthermore it is provided for that mounting feet and rollers are mounted underneath the base element, so that the lighting element can be freely put up or if need be moved or easily transported. The mounting surface can also be furnished with a base plate so that the lighting element can be directly placed on the floor in a stabile way without the use of feet or rollers, whereby the dust-tight attachment of the floor plate prevents dirt from penetrating into the lighting element.

In the especially advantageous embodiment of the invention it is provided for that the base element features at least one corresponding plug-in and/or socket connector for the attachment of further lighting elements and for the connection of further lighting elements. The plug-in connector can consist of one plug board and socket board, which produces an electrical and/or digital contact for the power supply and the control unit between the different lighting elements. Moreover, further connection elements can be provided for that make possible a plug-in, clamp and/or screw connection between the lighting elements. Through these designs several base elements or lighting elements can be connected to each other in a simple way. The use of a plug board makes in an especially advantageous way an additional wiring for the production of the electronic or digital connection superfluous. The individual lighting elements can be supplied with electricity through the plug board and in addition their control can be jointly coordinated. In this way only one lighting element must be connected to the electric circuit or the control center. Through this embodiment a simple and fast assembling of whole dividing walls or room dividers is possible, whereby the individual lighting elements are fused into a homogeneous unit. Disturbing effects are avoided by an additional wiring. Furthermore, independent of the accommodations to be equipped, lighting elements production technology can be standardized, which will make production cheaper and simplify assembly.

It is provided for in the embodiment of the invention that the base element forms a cuboid, a cube, a cone, a pyramid or similar regular or irregular geometric bodies. There are no limits to the creative diversity of the lighting elements with regard to their geometric form. It only must be guaranteed that the elements can be freely set up. The lighting elements can especially be used as furniture, e.g. room separating furniture, that optically leaves its mark on the room and at the same time illuminates it.

In further embodiment of the invention it is provided for that the side walls not used for lighting are covered by cover plates. For example, the side surfaces not needed, especially the side walls opposite neighboring elements, can be covered by the cover plates, whereby if need be the cover plates can feature a designer appearance.

The invention is furthermore explained in more detail on the basis of the figures.

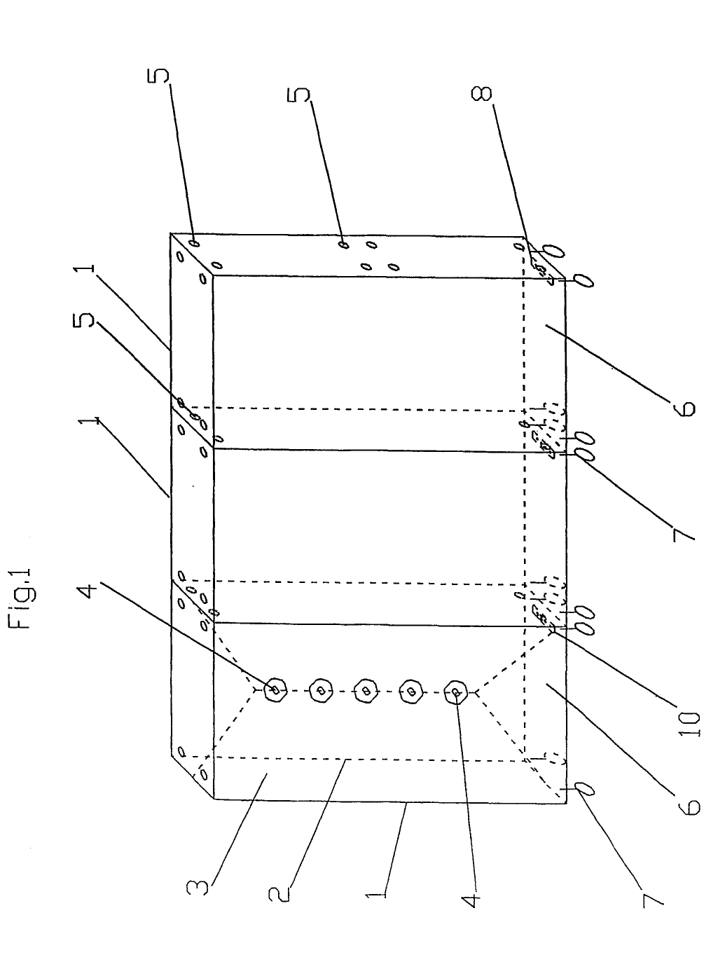

FIG. 1 shows a perspective view of a combination of three lighting elements of similar type,

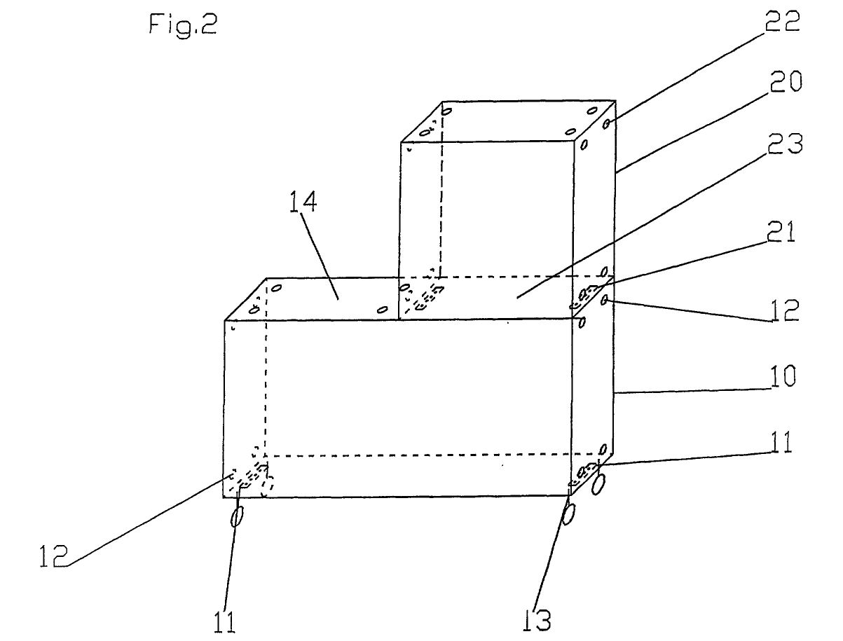

FIG. 2 shows a perspective view of two different lighting elements, and

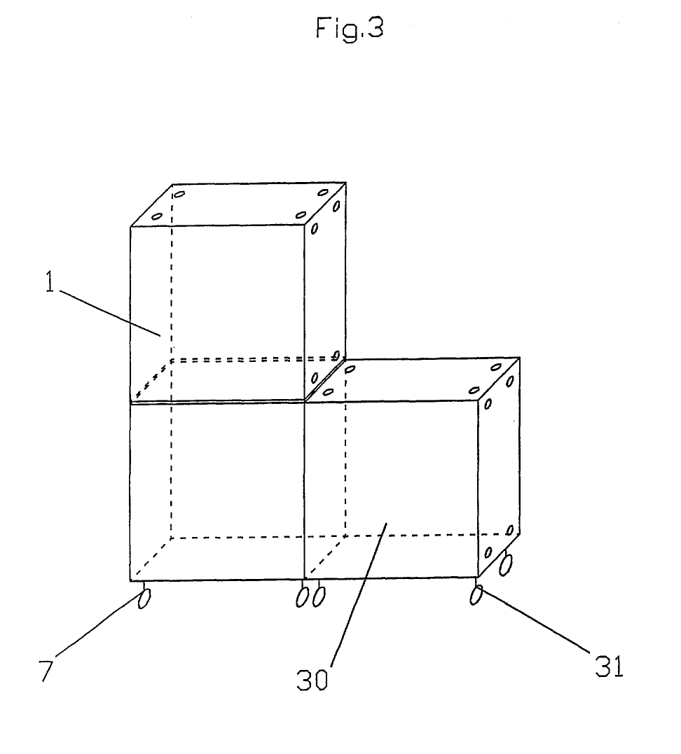

FIG. 3 shows a perspective view of two additional different lighting elements.

FIG. 1 shows a perspective view of three lighting elements 1, which are connected to each other. The individual lighting elements 1 feature a cuboid or cabinet form, whereby the form is formed by the base element 2. The base element 2 is covered on all side surfaces visible from outside with a translucent material, in this case a translucent PVC foil 3. Within the base element several light sources 4 are attached, which illuminate the lighting element from within. Since the translucent foil 3 is not transparent, the light sources 4 are not visible from outside. The foil 3 emits a wide spectrum of light to the outside, whereby the light is strongly dispersed and thus a homogeneous illumination of the room free of shadows can be achieved. Through the strong dispersion of the light the outlines of the light sources 4 located within become blurred, so that they are also not visible from outside when switched on. Furthermore, through the emission of a wide spectrum of light the impression of natural light is given, which is very pleasant to the observer. The lighting elements 1 feature on their side surfaces connection elements 5 through which the individual lighting elements 1 are connected to each other. The connection elements 5 can be plug-in, clamp or screw connections, so that a simple and quick assembly is possible. A homogenous unit results based on the stable connection between the individual lighting elements 1 so that they can be used for example as a dividing wall or room divider. The lighting elements 1 can be flexibly integrated in this way into the existing room structure as pieces of furniture or a structural element. The lighting elements 1 according to the invention thus practically fulfill a double function, whereby they serve on the one hand as a light and on the other hand as a furniture element. The setting up area arranged on the lower end of base element 2 is furnished in the embodiment example at hand with a base plate 6. The lighting element is stabilized in this way and moreover the penetration of dirt is prevented. Furthermore, rollers 7 are affixed underneath the base element 2, so that the lighting element 1 can be freely set up within the room and is easily moveable.

Furthermore a plug board, which contains plug fixtures for an electronic and digital connection, is attached to the base plate 6. Through this, an electrical and digital connection between the individual lighting elements 1 can be produced during the assembly in a simple and quick way, so that not every individual lighting element 1 must be separately attached to the electric circuit or to the respective control mechanism. Disturbing optical impressions caused by elaborate wiring can thus be avoided. For the complete supplying of all lighting elements 1 it would suffice if a lighting element 1, which for example is set up in the vicinity of a wall, is connected to the electric circuit or control. Through the possibility of a digital connection, individual lighting elements 1 can be controlled separately or in a coordinated fashion with regard to their lighting. The individual light sources 4 can, for example, be turned on and off dynamically and/or controlled in their intensity. In this way the most varied lighting effects can be generated, whereby dynamic and static images can be generated.

FIG. 2 shows the perspective view of two further lighting elements 10, 20, which are likewise connected to each other. Like the lighting elements 1 from FIG. 1, the lighting elements 10, 20 feature plug boards 11, 21 and further connection elements 12, 22, by which they are mechanically and electrically or digitally connected. The cuboid-shaped lighting element 10 is furnished on its underside with rollers so that it can be freely set up in the room and is moveable. The lighting element 20 features on the other hand no rollers, but rather is set down two-dimensionally with its mounting surface 23 on a part of the upper horizontal side surface of the connection element 10. The upper horizontal side surface of the lighting element 10 is furnished in the upper part with a plate element, which for example can serve as storage area. The combination of lighting elements 10, 20 shown in FIG. 2 is thus usable not only a light source, but rather also as a fully-fledged piece of furniture. In this way a novel, multi functional and very attractive furnishing of the room is possible.

FIG. 3 shows a lighting element 1 according to FIG. 1 in combination with a flat lighting element 3. Both lighting elements 1, 30 feature on their underside rollers 7, 31, so that the total combination can be freely set up and is moveable. The connection between the two lighting elements 1, 30 is produced in the same way here as already explained in FIGS. 1 and 2. As is shown from the totality of the FIGS. 1-3, the lighting elements can have different dimensions. For example, the supplying of standardized lighting elements with measurements of 90×90 cm and 90×180 cm or other corresponding measurements is provided for. The lighting elements 1, 30 can, for example, feature a depth of 30-40 cm. All sensible and aesthetic, geometric forms are possible since the lighting elements according to the invention are extremely variable. In an advantageous way, at least the two large area side surfaces opposite each other are covered with a translucent material so that the described optical effects can be realized, the sound absorbing effect of the lighting elements is guaranteed, and the interior of the lighting elements remains invisible from outside. For decorative reasons it is significant if the visible narrow side surfaces are furnished completely with translucent material. In this embodiment it is moreover especially advantageous if the whole combination of lighting elements is furnished on all sides with translucent material, whereby this should be covered in a dust-tight way in order to prevent the penetration of dirt particles into the interior of the lighting element.

Reference Character List

| | |
|---|---|
| 1 | Lighting element |
| 2 | Base element |
| 3 | Foil |
| 4 | Light source |
| 5 | Connection element |
| 6 | Base plate |
| 7 | Roller |
| 8 | Plug board |
| 10 | Lighting element |
| 11 | Plug board |
| 12 | Connection element |
| 13 | Roller |
| 14 | Plate element |
| 20 | Lighting element |
| 21 | Base element |
| 22 | Connection element |
| 23 | Mounting surface |
| 30 | Lighting element |
| 31 | Roller |

1. Lighting element (1, 10, 20, 30), consisting of at least one base element (2) and at least one light source arranged within the base element (2), which can be freely set up and at least partially on one side is covered with a translucent material, characterized in that
several regularly or irregularly arranged light sources (4) are provided, which are capable of being influenced by a color temperature control, and at least one side surface is completely covered with a translucent material.

2. Lighting element according to claim 1, characterized in that
at least two side surfaces arranged opposite or adjacent to each other are completely covered with a translucent material, whereby the sides are individually covered or covered with material wrapped around the corner areas.

3. Lighting element according to claim 1 and 2, characterized in that
the translucent material is a foil (3) or a textile material which is transparent to light of every wavelength.

4. Lighting element according to claim 1, 2, or 3, characterized in that
a foil (3) or the textile material is hung up with a piping that is at least partially wrapped around in a recess of the base element or a profile track.

5. Lighting element according to one or several of the claims 1 to 4, characterized in that
the translucent material consists of translucent plastic, for example PVC.

6. Lighting element according to one or several of the claims 1 to 5, characterized in that
the translucent material has an embossed knob-like structure and/or a micro perforation.

7. Lighting element according to one or several of the claims 1 to 6, characterized in that
individual light sources (4) emit monochromatic light.

8. Lighting element according to one or several of the claims 1 to 7, characterized in that
light technical devices for the generation of writing, images or visual representations, for example a starry sky, are present.

9. Lighting element according to one or several of the claims 1 to 8, characterized in that
several of the same or differently colored light sources (4) are provided, which are individually, dynamically, and in their intensity controllable.

10. Lighting element according to one or several of the claims 1 to 9, characterized in that
within the base element (2) additional electronic devices are provided, for example projectors for slides, acoustical reproduction devices or scent generators.

11. Lighting element according to one or several of the claims 1 to 10, characterized in that
the base element (2) consists of wood, plastic and/or metal, for example aluminum, and/or the base element (2) preferably consists of a frame element.

12. Lighting element according to one or several of the claims 1 to 11, characterized in that
plate elements (14) or grate elements are provided on the base element (2) on at least one, preferably horizontal, side surface.

13. Lighting element according to one or several of the claims 1 to 12, characterized in that
feet or rollers (7, 13, 31) are attached underneath the base element (2), and/or the mounting surface (23) is provided with a base plate (6).

14. Lighting element according to one or several of the claims 1 to 13, characterized in that
the base element (2) has at least one corresponding plug-in and/or socket connection for connecting several lighting elements (1, 10, 20, 30).

15. Lighting element according to claim 14, characterized in that
the plug-in connection consists of a plug panel (8, 11, 21) or socket panel, which produces an electrical and/or digital contact to the power supply and control unit, and/or that further contact elements (5, 12, 22) are provided that produce a plug-in, clamp and/or screw connection between the lighting elements (1, 10, 20, 30).

16. Lighting element according to one or several of the claims 1 to 15, characterized in that
the base element (2) forms a cuboid, a cube, a cone, pyramid or similar regular or irregular geometric bodies.

17. Lighting element according to one or several of the claims 1 to 16, characterized in that
it can be used as a piece of furniture, especially as a room dividing furniture.

18. Lighting element according to one or several of the claims 1 to 17, characterized in that
the side walls not intended for lighting are provided with cover plates.
